(19) United States
(12) Patent Application Publication
(10) Pub. No.: US 2014/0067447 A1
(43) Pub. Date: Mar. 6, 2014

(54) ERP TRANSACTION RECORDING TO API SYSTEM AND METHOD

(71) Applicants: Gurpreet Singh SIDHU, Chandigarh (IN); Vishal CHALANA, Panchkula (IN); Vikram CHALANA, Bothell, WA (US)

(72) Inventors: Gurpreet Singh SIDHU, Chandigarh (IN); Vishal CHALANA, Panchkula (IN); Vikram CHALANA, Bothell, WA (US)

(73) Assignee: WINSHUTTLE, LLC, Bothell, WA (US)

(21) Appl. No.: 13/598,433

(22) Filed: Aug. 29, 2012

(51) Int. Cl. G06Q 10/06

(52) U.S. Cl. 705/7.12

(57) ABSTRACT

An ERP client may automatically determine a list of one or more ERP database tables and fields that store the data associated with a particular business transaction in the ERP system. Various embodiments identify screen fields presented via the business transaction UI, map the screen fields to database-table fields, identify one or more application programming interface functions that operate on some or all of the same database-table fields, and report to the business user a list of some or all of the identified application programming interface functions.

### FIELD

The present disclosure relates to databases, and more particularly to methods of identifying application programming interface (“API”) functions that may be used to operate on business-transaction data similar to that entered and/or displayed via a business-transaction graphical user interface.

### BACKGROUND

Enterprise resource planning (“ERP”) systems, such as SAP ERP Central Component (“ECC”) provided by SAP AG of Weinheim, Germany, are designed to coordinate some or all of the resources, information, and activities needed to complete business processes. An ERP system may support business functions including some or all of manufacturing, supply chain management, financials, projects, human resources, customer relationship management, and the like.

Many ERP systems incorporate a centralized database or other ERP data store, and many ERP vendors provide an application programming interface (“API”) by which business transactions may be performed programmatically (as opposed to performing a business transaction via a user interface). However, it can be difficult for many business users, who may have little programming knowledge, to make use of an ERP business-transaction API (“BAPI”).

One factor that makes it harder for business users to effectively utilize BAPIs is the sheer volume of different BAPIs provided by the ERP system. For example, ECC version 6.0 provides approximately 4,000 distinct BAPI functions.

Business users, including business users with little or no programming skill, use business transaction user interface (“UI”) screens to query and extract information from one or more transaction-related database tables of an ERP system. For many business transactions (e.g., Purchase order creation, sales order creation, and the like), multiple table fields in multiple database tables may be referenced and/or updated in the course of performing the business transaction. In many cases, the ERP system may provide many different BAPI functions that operate on a similar set of database tables and fields. However, using existing tools, it can be difficult and cumbersome for a typical business user to manually identify such BAPI functions for a given business transaction.

### BRIEF DESCRIPTION OF THE DRAWINGS

FIG. 1 illustrates an exemplary ERP system in accordance with one embodiment.

FIG. 2 illustrates several components of an exemplary ERP client device in accordance with one embodiment.

FIG. 3 illustrates a conceptual overview of various data relationships in accordance with one embodiment.

FIG. 4 illustrates a routine for mapping screen UI fields associated with a business transaction to respectively corresponding ERP BAPI functions, in accordance with one embodiment.

FIG. 5 illustrates a subroutine for automatically obtaining a list of BAPI parameters of all available BAPI function, in accordance with one embodiment.

FIG. 6 illustrates a subroutine for selecting one or more BAPI functions from among a multiplicity of available BAPI functions, in accordance with one embodiment.

FIG. 7 illustrates a subroutine for providing a given list of one or more BAPI functions for presentation to a business user, in accordance with one embodiment.

FIGS. 8-12 depict various exemplary user interfaces illustrating various fields, tables, structures, characteristics, data objects, and/or concepts described herein.

### DESCRIPTION

According to various embodiments, as described below, an ERP client may automatically determine a list of one or more ERP database tables and fields that store the data associated with a particular business transaction in the ERP system. Various embodiments identify screen fields presented via the business transaction UI, map the screen fields to database-table fields, identify one or more application programming interface functions that operate on some or all of the same database-table fields, and report to the business user a list of some or all of the identified application programming interface functions.

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers, and memory storage devices. Each of these conventional distributed computing components is accessible by the processor via a communication network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications, and equivalents. In alternate embodiments, additional devices, or combinations of illustrated devices, may be added to, or combined, without limiting the scope to the embodiments disclosed herein.

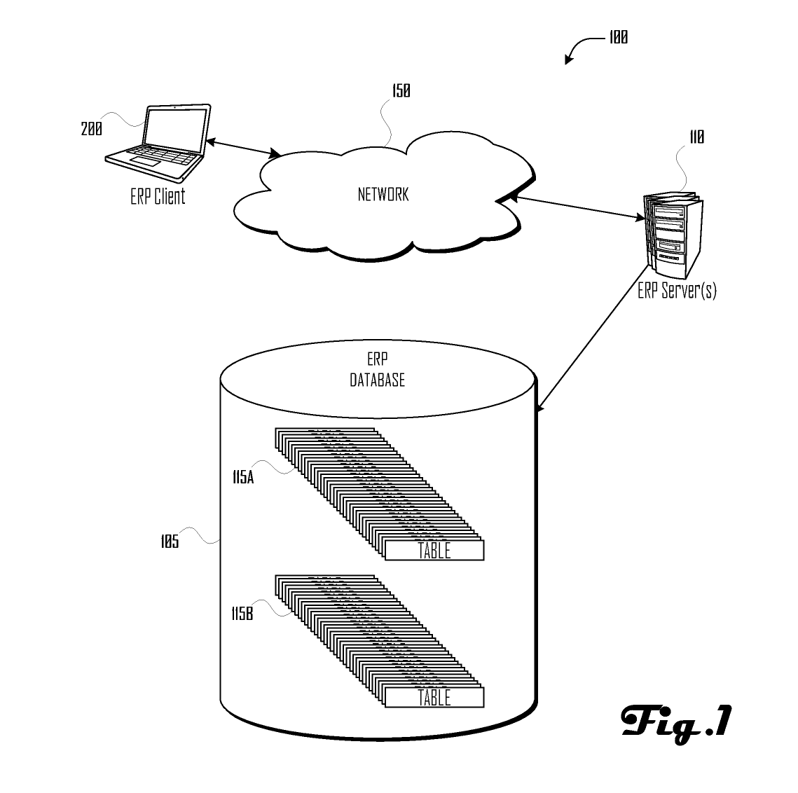

FIG. 1 illustrates an exemplary ERP system 100 in which an ERP client device 200 and one or more ERP Server(s) 110 are connected to a network 150. ERP Server(s) 110 is also in communication with an ERP database 105, which includes a multiplicity of persistent database tables 115A-B, each of which may include one or more table fields (not shown).

In some embodiments, ERP Server 110 may further comprise an application server (not shown), and/or ERP Server 110 may further include the functionality of an application server.

In various embodiments, network 150 may include the Internet, a local area network (“LAN”), a wide area network (“WAN”), and/or other data network.

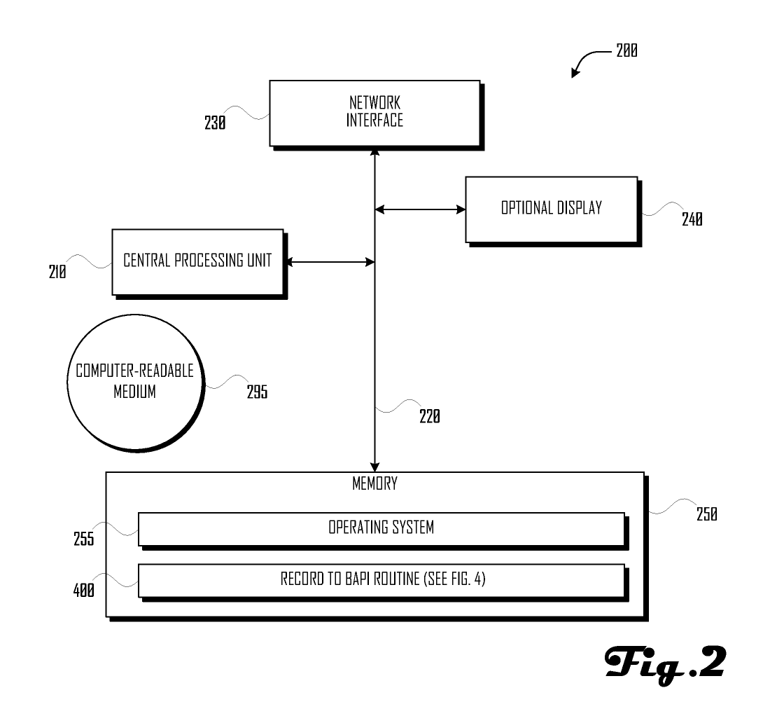

FIG. 2 illustrates several components of an exemplary ERP client device 200. In some embodiments, ERP client device 200 may include many more components than those shown in FIG. 2. However, it is not necessary that all of these generally conventional components be shown in order to disclose an illustrative embodiment. As shown in FIG. 2, the ERP client device 200 includes a network interface 230 for connecting to the network 150.

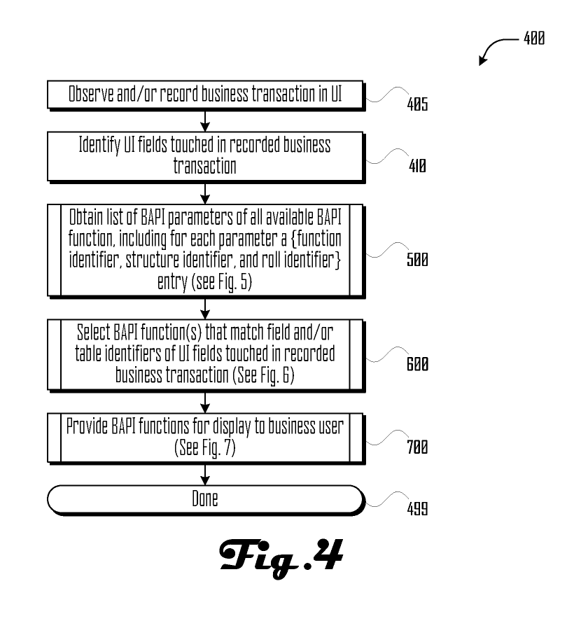

The ERP client device 200 also includes a processing unit 210, a memory 250, and an optional display 240, all interconnected along with the network interface 230 via a bus 220. The memory 250 generally comprises a random access memory (“RAM”), a read only memory (“ROM”), and a permanent mass storage device, such as a disk drive. The memory 250 stores program code for a record to BAPI routine 400 (see FIG. 4, discussed below). In addition, the memory 250 also stores an operating system 255. These software components may be loaded from a non-transitory, tangible, computer readable storage medium 295 into memory 250 of the ERP client device 200 using a drive mechanism (not shown) associated with a non-transient, tangible computer readable storage medium 295, such as a floppy disc, tape, DVD/CD-ROM drive, memory card, or the like. In some embodiments, software components may also be loaded via the network interface 230, rather than via a computer readable storage medium 295.

Although an exemplary ERP client device 200 has been described that generally conforms to conventional general purpose computing devices, an ERP client device 200 may be any of a great number of devices capable of communicating with the network 150 and/or ERP Server 110, for example, a personal computer, a game console, a set-top box, a handheld computer, a cell phone, or the like.

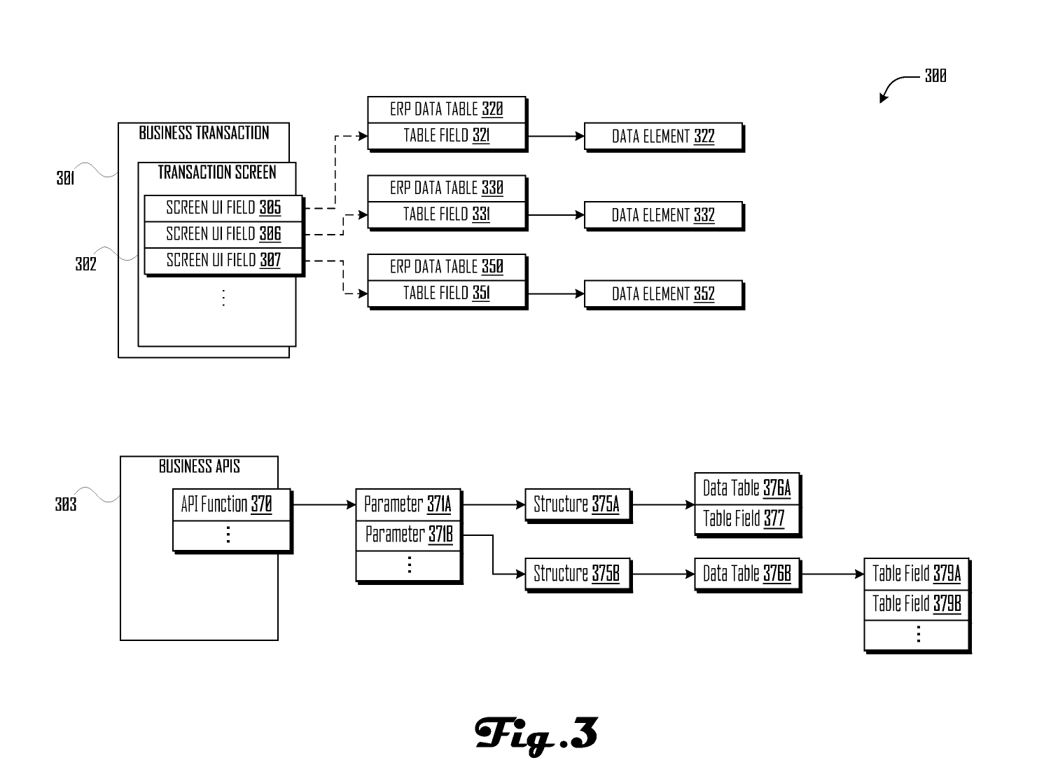

FIG. 3 illustrates a conceptual overview 300 of various data relationships in accordance with one embodiment. Business transaction 301 represents an ERP transaction defined and performed via at least one transaction screen 302, which typically includes several screen UI fields 305-307.

Each screen UI field (e.g., 305-307) typically corresponds to a particular field in a persistent database table in the ERP database. In some cases, there may be zero or more layers of indirection between a screen UI field and a corresponding persistent database table.

Various methods for dereferencing UI fields to identify a persistent database table, notwithstanding various layers of indirection, are described in co-pending U.S. patent application Ser. No. 13/464,707, titled “ERP Transaction Recording to Tables System and Method”, and filed May 4, 2012 under attorney docket number WINS-2012025.

For purposes of this disclosure, it is assumed that given a screen UI field, a corresponding field in a persistent database table can be identified using a standard ERP dereferencing function, using methods such as those described in co-pending application Ser. No. 13/464,707, or via other suitable means.

Database table fields (e.g., fields 321, 331, and 351) may also be associated with a “data element” (e.g., data elements 322, 332, and 352). In some embodiments, a data element is an elementary type, which describes the type attributes (e.g., data type, field length, possibly the number of decimal places, and the like) and content attributes such as screen information (e.g., explanatory text, field help, and the like) about unstructured data objects such as table fields, structure components, and the like. Table and UI fields and structure components that should have the same contents should refer to the same data element to ensure that the attributes of such fields remain consistent. In some embodiments, a data element may be identified using an identifier referred to as a “roll identifier” or “rollname”.

Business APIs 303 represents a collection of API functions (e.g., API function 370) that are provided by an ERP system for performing business transactions. An API function typically has one or more input parameters (e.g., parameters 371A-B), each of which is associated with a “structure” (e.g., structures 375A-B) A structure is a template of a field of a database table or of a database table, the structure fields being filled with data values at the time of program execution. Structures are temporary or non-persistent intermediates, typically located in RAM or other short-term memory, where data is stored while it is being processed by a program. For example, as illustrated in FIG. 3, structure 375A corresponds to table field 377 of data table 376A, while structure 375B corresponds to data table 376B. As discussed above, database tables typically include one or more fields, such as table fields 379A-B or data table 376B.

FIG. 4 illustrates a routine 400 for identifying and presenting API functions that operate on a similar set of database table fields as one or more screen UI fields associated with a business transaction, in accordance with one embodiment. In block 405, routine 400 observes and/or records a business transaction as performed by a business user via one or more UI screens.

Based on the recording and/or observation, in block 410, routine 400 determines a list of one or more screen UI fields that are involved in the business transaction. For example, in one embodiment, the list may include all screen UI fields of all UI screens of the business transaction.

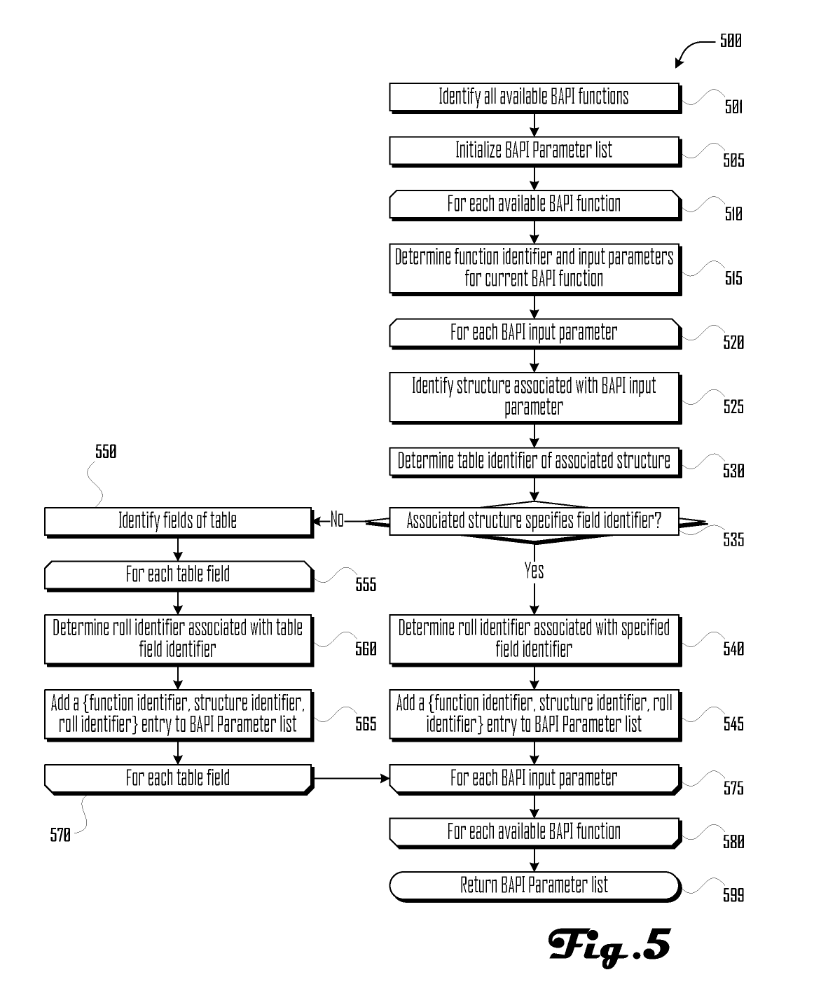

In subroutine block 500 (see FIG. 5, discussed below), routine 400 automatically obtains a list of BAPI parameters of all available BAPI function, including for each parameter, identifiers identifying a corresponding function, data element (identified by a roll identifier), and structure. For example, in one embodiment, subroutine 500 may return a list including data similar to that shown in Table 1.

TABLE 1

| Parameter | Function Identifier | Structure Identifier | Roll identifier |
|---|---|---|---|
| MATERIAL | BAPI_MATERIAL_EDIT | BAPIMATALL-MATERIAL | BAPIMATALL-MATERIAL |
| MATERIAL_EVG | BAPI_MATERIAL_EDIT | BAPIMGVMATNR | BAPIMGVMATNR |
| SKIP_1ST_SCREEN | BAPI_MATERIAL_EDIT | BAPIMATALL- | BAPIMATALL- |
| | | SKIP_1ST_SCREEN | SKIP_1ST_SCREEN |

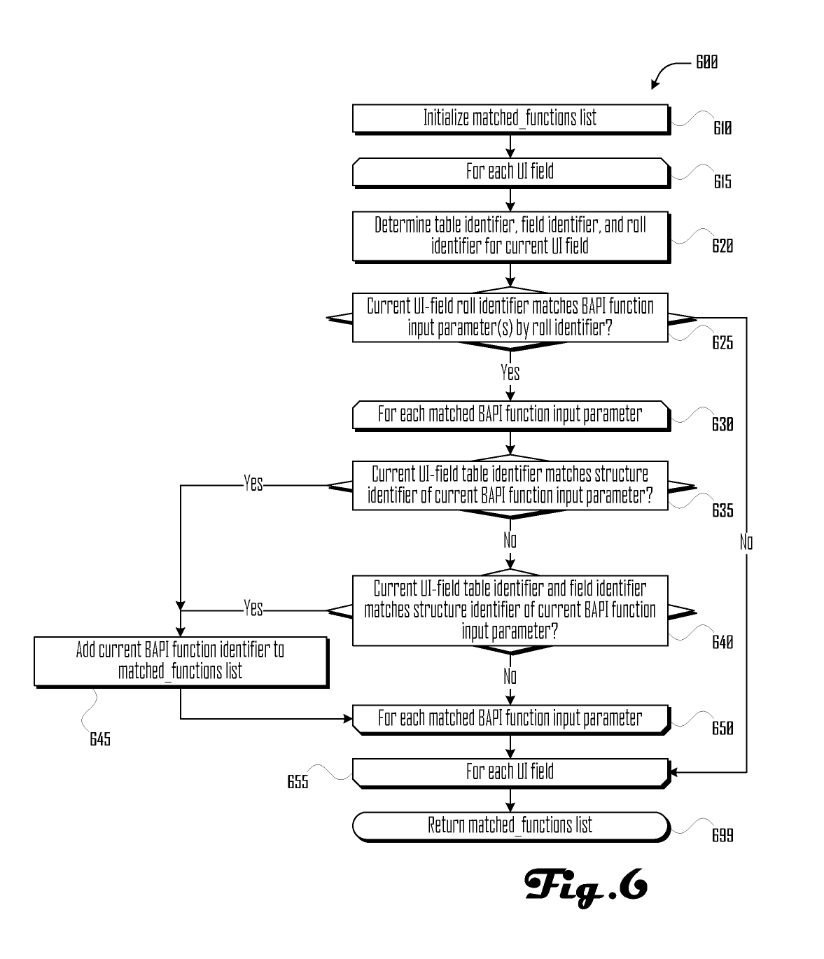

In subroutine block 600 (see FIG. 6, discussed below), routine 400 selects one or more BAPI functions from among a multiplicity of available BAPI functions, the selected BAPI functions having been determined to have parameters that match field and/or table identifiers of some or all of the screen UI fields identified in block 410.

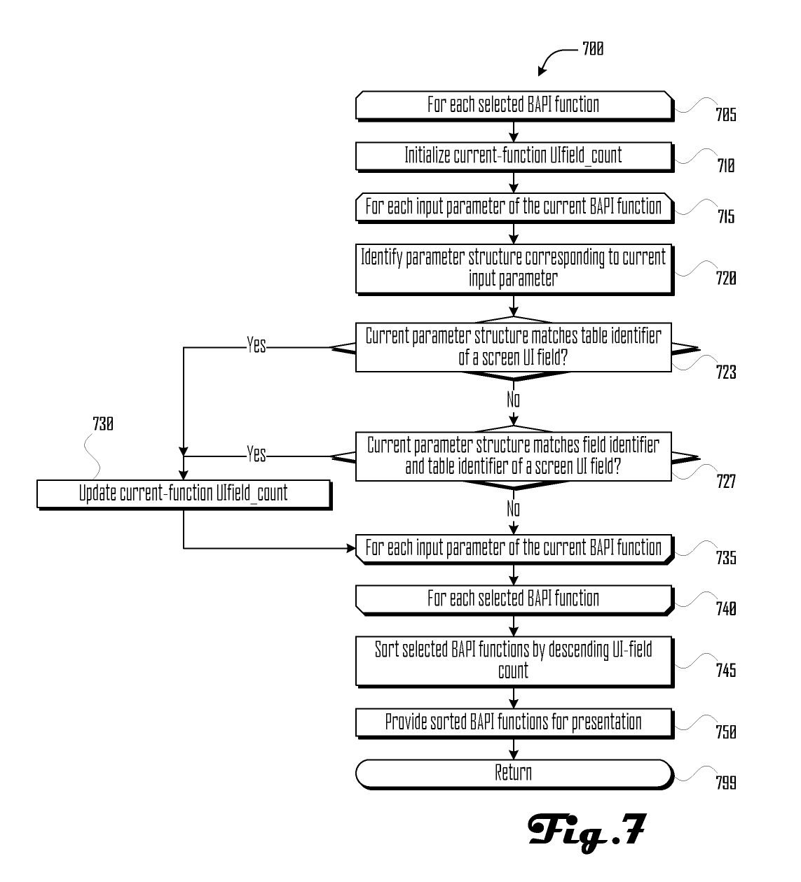

In subroutine block 700 (see FIG. 7, discussed below), routine 400 provides a list of the one or more BAPI functions (selected in subroutine block 600) for presentation to a business user. Routine 400 ends in block 499.

FIG. 5 illustrates a subroutine 500 for automatically obtaining a list of BAPI parameters of all available BAPI function, in accordance with one embodiment. In block 501, subroutine 500 obtains a multiplicity of BAPI functions that are available within the ERP system.

In block 505, subroutine 500 initializes a BAPI Parameter list to store (at least transiently) BAPI parameter metadata as discussed further below. As the term is used herein, “initialize” refers to setting a variable, field, or other data structure to an initial state. In some cases, initializing may include allocating transient memory to store the data structure, and in some cases, the initial state may be an empty state.

In various embodiments, the BAPI Parameter “list” may comprise, at various times, a list, array, hash, XML data, one or more database tables, or other like data structure stored in transient or persistent memory. In some embodiments, the BAPI Parameter “list” may further be capable of associating two pieces of data with one another. For example, in one embodiment, the BAPI Parameter list may include a list (or array, or hash, or the like) of key-value pairs or similar associative structure. In other embodiments, the BAPI Parameter list may include a pair of parallel lists (or arrays or the like), with associated entries being stored at related indices. In still other embodiments, any other suitable data structure may be employed.

Beginning in opening loop block 510, subroutine 500 processes each of the BAPI functions identified in block 501. In block 515, subroutine 500 determines for the current BAPI function a function name or other function identifier and a set of one or more input parameters for the current BAPI function. See, e.g., columns 1 and 2 of Table 1, above. For example, in one embodiment, such BAPI function metadata may be determined by accessing one or more ERP tables (e.g., table FUPARAREF in an SAP ERP system) storing such metadata.

Beginning in opening loop block 520, subroutine 500 processes each of the input parameters determined in block 515 for the current BAPI function. In block 525, subroutine 500 identifies a structure associated with the current BAPI input parameter. For example, in one embodiment, a structure associated with the current BAPI input parameter may be determined by accessing one or more ERP tables (e.g., table FUPARAREF in an SAP ERP system) storing such metadata.

In various embodiments, a structure identifier may be a string including an optional delimiter string (e.g., “-”). For example, as shown in Table 1 above, a structure identifier may have no delimiter (e.g., “BAPIMGVMATNR”) or one delimiter (e.g., “BAPIMATALL-MATERIAL”).

In block 530, subroutine 500 determines a table identifier identifying a data table corresponding to the structure identified in block 525 for the current BAPI function input parameter. For example, in one embodiment, a table identifier may be a string corresponding to a portion of the structure identifier from the beginning of the structure identifier string up to an optional delimiter string (if present, e.g., “BAPIMATALL”) or to the end of the string (if no delimiter is present, e.g., “BAPIMGVMATNR”).

In decision block 535, subroutine 500 determines whether the structure identified in block 525 specifies a table-field identifier identifying a field of a data table. For example, in one embodiment, if the structure identifier includes a delimiter string (e.g., “-”), then subroutine 500 may determine that the structure specifies a table-field identifier (e.g., “MATERIAL”) and proceed to block 540 to determine a roll identifier identifying a data element associated with the specified table field. In block 545, subroutine 500 adds to the BAPI Parameter list initialized in block 505 an entry including at least the function identifier determined in block 515, the structure identifier determined in block 525, and the roll identifier determined in block 540.

Otherwise, if in decision block 535, subroutine 500 determined that the structure identified in block 525 does not specify a table-field identifier, then in block 550, subroutine 500 identifies one or more fields that comprise the identified data table. Beginning in opening loop block 555, subroutine 500 processes each table field in turn.

In block 560, subroutine 500 determines a roll identifier identifying a data element associated with the current table field. In block 565, subroutine 500 adds to the BAPI Parameter list initialized in block 505 an entry including at least the function identifier determined in block 515, the structure identifier determined in block 525, and the roll identifier determined in block 560.

In closing loop block 570, subroutine 500 iterates back to block 555 to process the next table field (if any). Once all table fields have been processed, in ending block 575, subroutine 500 iterates back to block 520 to process the next BAPI function input parameter (if any). Once all input parameters have been processed, in ending block 580, subroutine 500 iterates back to block 510 to process the next BAPI function (if any). Once all BAPI functions have been processed, subroutine 500 ends in block 599.

FIG. 6 illustrates a subroutine 600 for selecting one or more BAPI functions from among a multiplicity of available BAPI functions, the selected BAPI functions comprising a subset of the available BAPI functions that have been determined to have parameters that match field and/or table identifiers of some or all of a given set of screen UI fields, in accordance with one embodiment.

In block 610, subroutine 600 initializes a matched_functions list to store (at least transiently) BAPI function metadata as discussed further below. In various embodiments, the matched_functions “list” may comprise, at various times, a list, array, hash, XML data, one or more database tables, or other like data structure stored in transient or persistent memory. In some embodiments, the matched_functions “list” may further be capable of associating two pieces of data with one another. For example, in one embodiment, the matched_functions list may include a list (or array, or hash, or the like) of key-value pairs or similar associative structure. In other embodiments, the matched_functions list may include a pair of parallel lists (or arrays or the like), with associated entries being stored at related indices. In still other embodiments, any other suitable data structure may be employed.

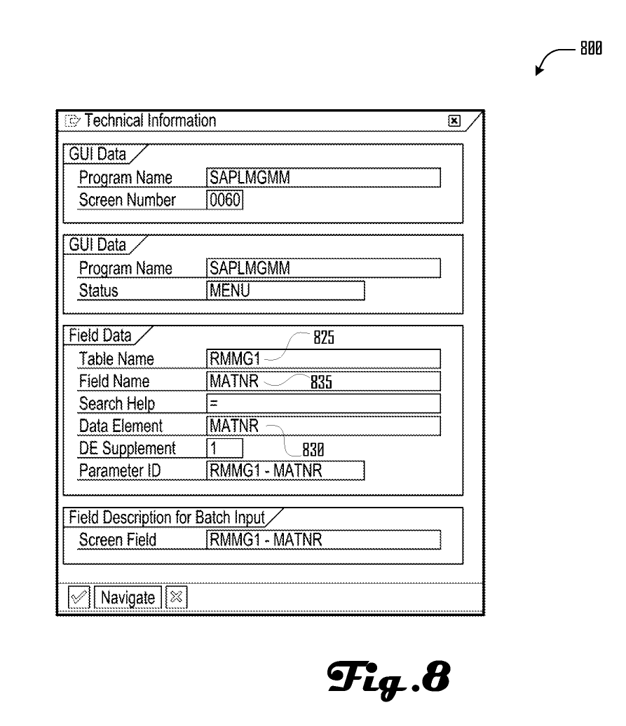

Beginning in opening loop block 615, subroutine 600 processes each of the given screen UI fields in turn. In block 620, subroutine 600 determines for the current screen UI field a corresponding data table identifier, table-field identifier, and roll identifier. See, e.g., screen UI technical information shown in FIG. 8, discussed below.

In decision block 625, subroutine 600 determines whether the UI-field roll identifier determined in block 620 matches roll identifiers corresponding to one or more BAPI function input parameters (see blocks 545 and 565 of FIG. 5, discussed above). If not, then subroutine 600 skips to closing loop block 655 and iterates back to block 615 to process the next screen UI field (if any).

On the other hand, if in decision block 625, subroutine 600 determines that the UI-field roll identifier determined in block 620 matches roll identifiers corresponding to one or more BAPI function input parameters, then beginning in opening loop block 630, subroutine 600 processes each of the matching BAPI function input parameters in turn.

In decision block 635, subroutine 600 determines whether the current UI-field table identifier (determined in block 620) matches the structure identifier of the current matching BAPI function input parameter (see block 525 of FIG. 5, discussed above). For example, in decision block 635, subroutine 600 would find a match between a UI-field table identifier of “BAPIMGVMATNR” and a BAPI-function-input-parameter structure identifier of “BAPIMGVMATNR”. Conversely, in decision block 635, subroutine 600 would not find a match between a UI-field table identifier of “BAPIMGVMATNR-MATNR” and a BAPI-function-input-parameter structure identifier of “BAPIMGVMATNR”.

If in decision block 635, subroutine 600 determines that the current UI-field table identifier does match the structure identifier of the current matching BAPI function input parameter, then in block 645, subroutine 600 adds the current BAPI function identifier to the matched_functions list initialized in block 610.

Otherwise, if in decision block 635, subroutine 600 determines that the current UI-field table identifier does not match the structure identifier of the current matching BAPI function input parameter, then in decision block 640, subroutine 600 determines whether the current UI-field table identifier and table-field identifier (determined in block 620) match the structure identifier of the current matching BAPI function input parameter. For example, in decision block 640, subroutine 600 would find a match between a UI-field table identifier of “BAPIMATALL-MATERIAL” and a BAPI-function-input-parameter structure identifier of “BAPIMATALL-MATERIAL”. Conversely, in decision block 635, subroutine 600 would not find a match between a UI-field table identifier of “BAPIMATALL” and a BAPI-function-input-parameter structure identifier of “BAPIMATALL-MATERIAL”.

If in decision block 640, subroutine 600 determines that the current UI-field table identifier and table-field identifier does match the structure identifier of the current matching BAPI function input parameter, then in block 645, subroutine 600 adds the current BAPI function identifier to the matched_functions list initialized in block 610.

In closing loop block 650, subroutine 600 iterates back to block 630 to process the next BAPI function input parameter (if any). Once all BAPI function input parameters have been processed, in closing loop block 655, subroutine 600 iterates back to block 615 to process the next screen UI field (if any). Once all screen UI fields have been processed, subroutine 600 ends in block 699, returning to the caller the matched_functions list.

FIG. 7 illustrates a subroutine 700 for providing a given list of one or more BAPI functions for presentation to a business user in relation to a given business transaction UI screen having one or more screen UI fields, in accordance with one embodiment.

Beginning in opening loop block 705, subroutine 700 processes each of the given BAPI functions in turn. In block 710, subroutine 700 initializes a UIfield_count variable (or other suitable incrementable data store) corresponding to the current BAPI function, e.g., to an initial value of zero.

Beginning in opening loop block 715, subroutine 700 processes each input parameter of the current BAPI function in turn. In block 720, subroutine 700 identifies a parameter structure corresponding to the current BAPI function input parameter. See, e.g., column 3 of Table 1, above.

In decision block 723, subroutine 700 determines whether the parameter structure identified in block 720 matches a table identifier of a screen UI field of the given business transaction UI screen. For example, in decision block 723, subroutine 700 would find a match between a UI-field table identifier of “BAPIMGVMATNR” and a BAPI-function-input-parameter structure identifier of “BAPIMGVMATNR”. Conversely, in decision block 723, subroutine 700 would not find a match between a UI-field table identifier of “BAPIMGVMATNR-MATNR” and a BAPI-function-input-parameter structure identifier of “BAPIMGVMATNR”.

If in decision block 723, subroutine 700 determines that the parameter structure identified in block 720 does match a table identifier of a screen UI field of the given business transaction UI screen, then in block 730, subroutine 700 updates the UIfield_count variable corresponding to the current BAPI function, e.g., by incrementing its value.

Otherwise, if in decision block 723, subroutine 700 determines that the parameter structure identified in block 720 does not match a table identifier of a screen UI field of the given business transaction UI screen, then in decision block 727, subroutine 700 determines whether the parameter structure identified in block 720 matches a table identifier and a table-field identifier of the given business transaction UI screen. For example, in decision block 727, subroutine 700 would find a match between a UI-field table identifier of “BAPIMATALL-MATERIAL” and a BAPI-function-input-parameter structure identifier of “BAPIMATALL-MATERIAL”. Conversely, in decision block 723, subroutine 700 would not find a match between a UI-field table identifier of “BAPIMATALL” and a BAPI-function-input-parameter structure identifier of “BAPIMATALL-MATERIAL”.

If in decision block 727, subroutine 700 determines that the parameter structure identified in block 720 does match a table identifier and a table-field identifier of a screen UI field of the given business transaction UI screen, then in block 730, subroutine 700 updates the UIfield_count variable corresponding to the current BAPI function, e.g., by incrementing its value.

In closing loop block 735, subroutine 700 iterates back to block 715 to process the next input parameter of the current BAPI function (if any). Once all input parameters of the current BAPI function have been processed, in closing loop block 740, subroutine 700 iterates back to block 705 to process the next BAPI function (if any). Once all BAPI functions have been processed, in block 745, subroutine 700 sorts the given BAPI functions in descending order according to the UI field count values determined in iterations of blocks 725 and 730, such that BAPI functions with a higher UI field count value appear higher in the sorted list.

In block 750, subroutine 700 provides the sorted BAPI functions for presentation to a business user. Subroutine 700 ends in block 799, returning to the caller.

FIG. 8 illustrates an exemplary user interface 800 showing various pieces of technical information associated with a given screen UI field, including a name 825 of a data table associated with the screen UI field, a name 835 of a table field associated with the screen UI field, and a data element or roll identifier 830 corresponding to the screen UI field.

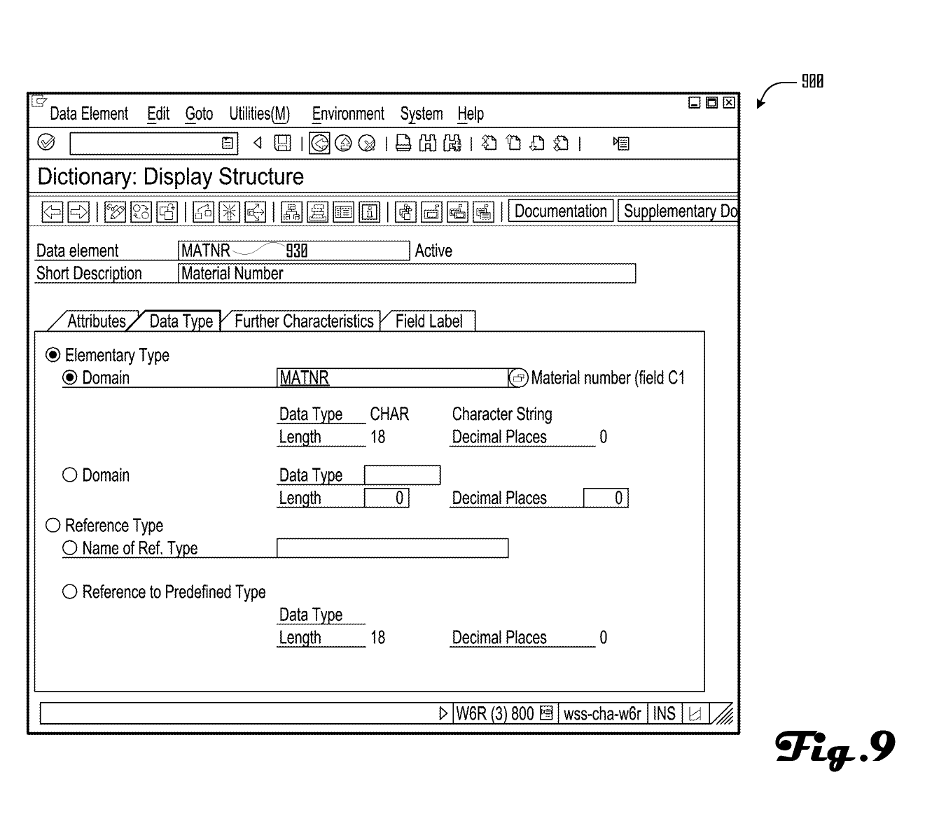

FIG. 9 illustrates an exemplary user interface 900 showing information about data element 930.

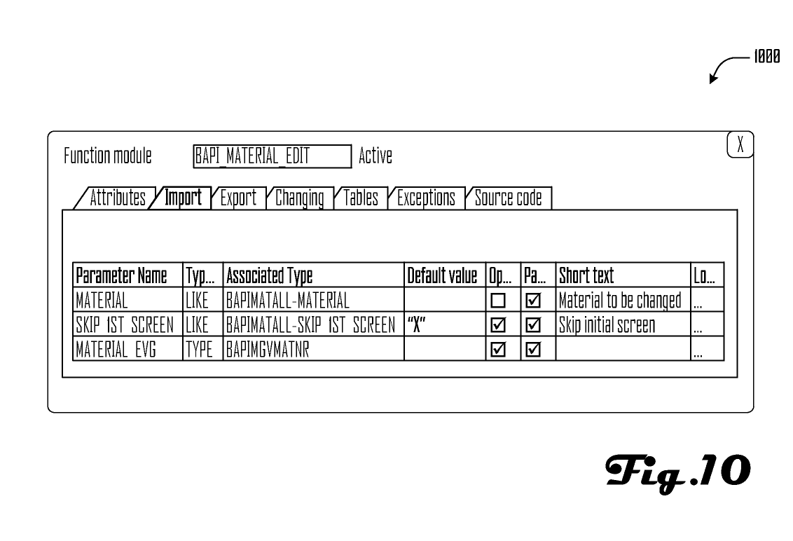

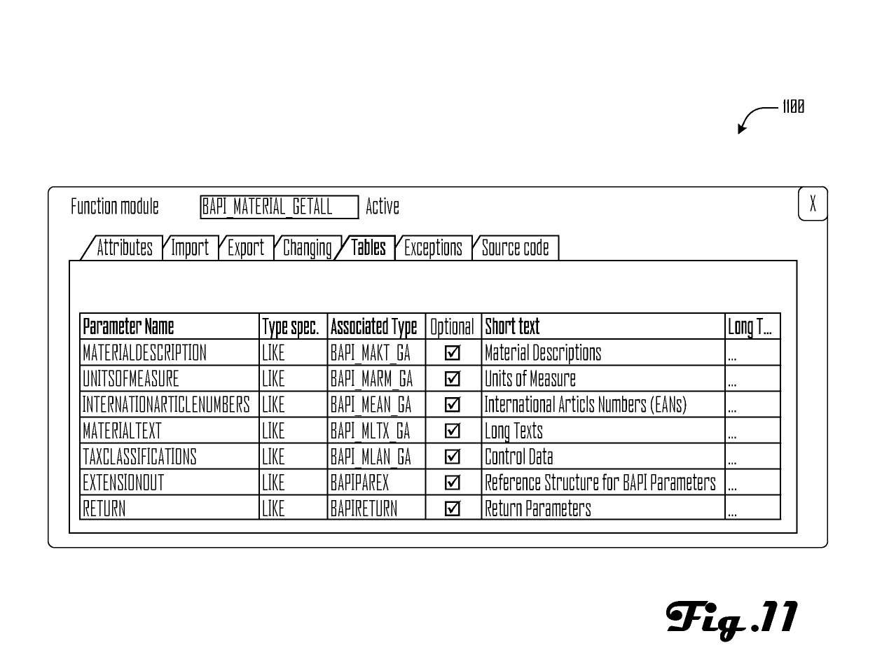

FIGS. 10 and 11 illustrate exemplary user interfaces 1000 and 1100 showing input parameter metadata corresponding to BAPI functions “BAPI_MATERIAL_EDIT” and “BAPI_MATERIAL_GETALL”, respectively.

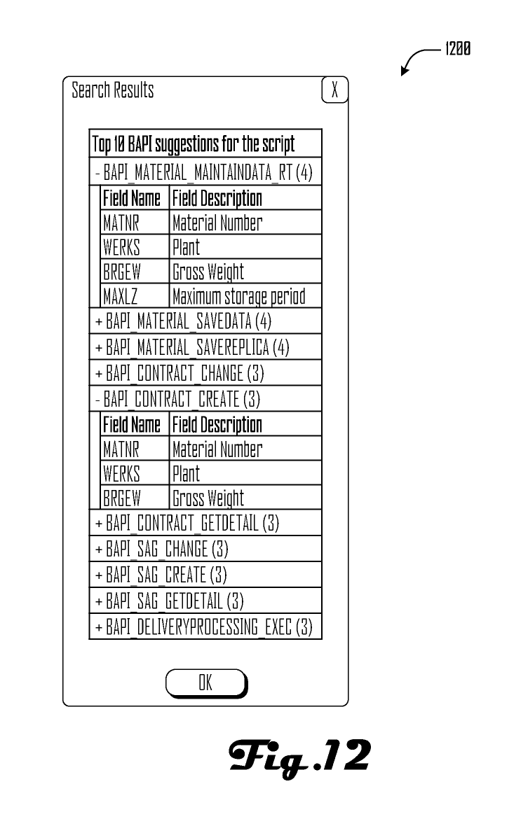

FIG. 12 illustrates an exemplary user interface 1200 identifying a sorted list of BAPI functions that have been determined to be associated with a number of screen UI fields (either three or four screen UI fields, as illustrated) of a recorded business transaction. User interface 1200 also shows matching field names and descriptions for two of the BAPI functions.

Although specific embodiments have been illustrated and described herein, it will be appreciated by those of ordinary skill in the art that a whole variety of alternate and/or equivalent implementations may be substituted for the specific embodiments shown and described without departing from the scope of the present invention. For example, although the description above refers to embodiments involving enterprise resource planning systems, other embodiments may be similarly used in other types of enterprise application systems in which a transaction between an enterprise client and an enterprise server may be recorded and mapped, as variously described above. For example, the systems and methods described herein may be used in connection with enterprise systems such as customer relationship management (“CRM”) systems, accounting systems, supply chain management systems, and the like. This application is intended to cover any adaptations or variations of the embodiments discussed herein.

What is claimed is:

1. A computer-implemented method for selecting, from among a multiplicity of application programming interface (“API”) functions of an Enterprise Resource Planning (“ERP”) system, one or more API functions that are associated with a business transaction, the method comprising:
identifying, by the computer, a user interface (“UI”) field of a plurality of UI fields of a transaction UI for retrieving business-transaction data from and/or submitting said business-transaction data to the ERP system, said UI field being configured to present and/or collect a business-transaction datum of said business-transaction data;
determining, by the computer, UI-field metadata associated with said UI field;
identifying, by the computer, a multiplicity of API-function input parameters corresponding to the multiplicity of API functions of the ERP system;
determining, by the computer, API-parameter metadata associated with each of said plurality of multiplicity of API-function input parameters;
using said UI-field metadata and said API-parameter metadata, the computer automatically selecting one or more API function identifiers identifying one or more API functions that can be used to retrieve said business-transaction datum from and/or submit said business-transaction datum to the ERP system in a manner similar to said transaction UI; and
providing, by the computer for display to a business user of the ERP system, an API-function-identification UI including said one or more API function identifiers.

2. The method of claim 1, wherein determining said UI-field metadata comprises identifying:
a UI-field data-table identifier identifying an ERP data table associated with said UI field;
a UI-field table-field identifier identifying a table field of said ERP data table; and
a UI-field data-element identifier identifying a data element describing type and content attributes of said table field.

3. The method of claim 2, wherein determining said API-parameter metadata comprises determining, for said multiplicity of API-function input parameters:
a multiplicity of structure identifiers respectively identifying a multiplicity of structures, each corresponding to one of said multiplicity of ERP data-table fields or to one of said multiplicity of ERP data tables; and
a multiplicity of data-element identifiers respectively identifying a multiplicity of data elements, each describing type and content attributes of one of said multiplicity of ERP data-table fields.

4. The method of claim 3, wherein for a given API-function input parameter of said multiplicity of API-function input parameters, determining a data-element identifier comprises:
determining, based on a structure identifier of said given API-function input parameter, an API table identifier and an API table-field identifier identifying a field of an ERP data table associated with said given API-function input parameter; and
identifying the data-element identifier as being associated with said field of said ERP data table.

5. The method of claim 3, wherein for a given API-function input parameter of said multiplicity of API-function input parameters, determining one or more data-element identifiers comprises:
determining, based on a structure identifier of said given API-function input parameter, an API table identifier identifying an ERP data table associated with said given API-function input parameter;
determining one or more API table-field identifiers respectively identifying one or more table-fields of said ERP data table; and
identifying the one or more data-element identifiers as being respectively associated with said one or more table-fields of said ERP data table.

6. The method of claim 3, wherein automatically selecting said one or more API function identifiers comprises identifying a subset of said multiplicity of API-function input parameters wherein members of said subset have a data-element identifier that matches said UI-field data-element identifier.

7. The method of claim 6, wherein automatically selecting said one or more API function identifiers further comprises selecting one or more members of said subset wherein the selected one or more members have a structure identifier that corresponds to said ERP data table.

8. The method of claim 6, wherein automatically selecting said one or more API function identifiers further comprises selecting one or more members of said subset wherein the selected one or more members have a structure identifier that corresponds to said table field of said ERP data table.

9. The method of claim 1, further comprising determining a plurality of counts respectively indicating how many of said plurality of UI fields correspond to an input parameter of a respective one of said one or more identified API functions.

10. The method of claim 9, wherein providing said API-function-identification UI comprises sorting said one or more API function identifiers in descending order according to said plurality of counts.

11. A non-transitory, computer-readable storage medium having stored thereon instructions that when executed by a processor, configure the processor to perform a method for selecting, from among a multiplicity of application programming interface (“API”) functions of an Enterprise Resource Planning (“ERP”) system, one or more API functions that are associated with a business transaction, the method comprising:
identifying a user interface (“UI”) field of a plurality of UI fields of a transaction UI for retrieving business-transaction data from and/or submitting said business-transaction data to the ERP system, said UI field being configured to present and/or collect a business-transaction datum of said business-transaction data;
determining UI-field metadata associated with said UI field;
identifying a multiplicity of API-function input parameters corresponding to the multiplicity of API functions of the ERP system;
determining API-parameter metadata associated with each of said plurality of multiplicity of API-function input parameters;
using said UI-field metadata and said API-parameter metadata, automatically selecting one or more API function identifiers identifying one or more API functions that can be used to retrieve said business-transaction datum from and/or submit said business-transaction datum to the ERP system in a manner similar to said transaction UI; and
providing, for display to a business user of the ERP system, an API-function-identification UI including said one or more API function identifiers.

12. The storage medium of claim 11, wherein determining said UI-field metadata comprises identifying:
a UI-field data-table identifier identifying an ERP data table associated with said UI field;
a UI-field table-field identifier identifying a table field of said ERP data table; and
a UI-field data-element identifier identifying a data element describing type and content attributes of said table field.

13. The storage medium of claim 12, wherein determining said API-parameter metadata comprises determining, for said multiplicity of API-function input parameters:
a multiplicity of structure identifiers respectively identifying a multiplicity of structures, each corresponding to one of said multiplicity of ERP data-table fields or to one of said multiplicity of ERP data tables; and
a multiplicity of data-element identifiers respectively identifying a multiplicity of data elements, each describing type and content attributes of one of said multiplicity of ERP data-table fields.

14. The storage medium of claim 13, wherein for a given API-function input parameter of said multiplicity of API-function input parameters, determining a data-element identifier comprises:
determining, based on a structure identifier of said given API-function input parameter, an API table identifier and an API table-field identifier identifying a field of an ERP data table associated with said given API-function input parameter; and
identifying the data-element identifier as being associated with said field of said ERP data table.

15. The storage medium of claim 13, wherein for a given API-function input parameter of said multiplicity of API-function input parameters, determining one or more data-element identifiers comprises:
determining, based on a structure identifier of said given API-function input parameter, an API table identifier identifying an ERP data table associated with said given API-function input parameter;
determining one or more API table-field identifiers respectively identifying one or more table-fields of said ERP data table; and
identifying the one or more data-element identifiers as being respectively associated with said one or more table-fields of said ERP data table.

16. The storage medium of claim 13, wherein automatically selecting said one or more API function identifiers comprises identifying a subset of said multiplicity of API-function input parameters wherein members of said subset have a data-element identifier that matches said UI-field data-element identifier.

17. The storage medium of claim 16, wherein automatically selecting said one or more API function identifiers further comprises selecting one or more members of said subset wherein the selected one or more members have a structure identifier that corresponds to said ERP data table.

18. The storage medium of claim 16, wherein automatically selecting said one or more API function identifiers further comprises selecting one or more members of said subset wherein the selected one or more members have a structure identifier that corresponds to said table field of said ERP data table.

19. The storage medium of claim 11, the method further comprising determining a plurality of counts respectively indicating how many of said plurality of UI fields correspond to an input parameter of a respective one of said one or more identified API functions.

20. The storage medium of claim 19, wherein providing said API-function-identification UI comprises sorting said one or more API function identifiers in descending order according to said plurality of counts.

21. A computing apparatus comprising a processor and a storage medium having stored thereon instructions that when executed by the processor, configure the apparatus to perform a method for selecting, from among a multiplicity of application programming interface (“API”) functions of an Enterprise Resource Planning (“ERP”) system, one or more API functions that are associated with a business transaction, the method comprising:
identifying a user interface (“UI”) field of a plurality of UI fields of a transaction UI for retrieving business-transaction data from and/or submitting said business-transaction data to the ERP system, said UI field being configured to present and/or collect a business-transaction datum of said business-transaction data;
determining UI-field metadata associated with said UI field;
identifying a multiplicity of API-function input parameters corresponding to the multiplicity of API functions of the ERP system;
determining API-parameter metadata associated with each of said plurality of multiplicity of API-function input parameters;
using said UI-field metadata and said API-parameter metadata, automatically selecting one or more API function identifiers identifying one or more API functions that can be used to retrieve said business-transaction datum from and/or submit said business-transaction datum to the ERP system in a manner similar to said transaction UI; and
providing, for display to a business user of the ERP system, an API-function-identification UI including said one or more API function identifiers.

22. The apparatus of claim 21, wherein determining said UI-field metadata comprises identifying:
a UI-field data-table identifier identifying an ERP data table associated with said UI field;
a UI-field table-field identifier identifying a table field of said ERP data table; and
a UI-field data-element identifier identifying a data element describing type and content attributes of said table field.

23. The apparatus of claim 22, wherein determining said API-parameter metadata comprises determining, for said multiplicity of API-function input parameters:
a multiplicity of structure identifiers respectively identifying a multiplicity of structures, each corresponding to one of said multiplicity of ERP data-table fields or to one of said multiplicity of ERP data tables; and
a multiplicity of data-element identifiers respectively identifying a multiplicity of data elements, each describing type and content attributes of one of said multiplicity of ERP data-table fields.

24. The apparatus of claim 23, wherein for a given API-function input parameter of said multiplicity of API-function input parameters, determining a data-element identifier comprises:
determining, based on a structure identifier of said given API-function input parameter, an API table identifier and an API table-field identifier identifying a field of an ERP data table associated with said given API-function input parameter; and
identifying the data-element identifier as being associated with said field of said ERP data table.

25. The apparatus of claim 23, wherein for a given API-function input parameter of said multiplicity of API-function input parameters, determining one or more data-element identifiers comprises:
determining, based on a structure identifier of said given API-function input parameter, an API table identifier identifying an ERP data table associated with said given API-function input parameter;
determining one or more API table-field identifiers respectively identifying one or more table-fields of said ERP data table; and
identifying the one or more data-element identifiers as being respectively associated with said one or more table-fields of said ERP data table.

26. The apparatus of claim 23, wherein automatically selecting said one or more API function identifiers comprises identifying a subset of said multiplicity of API-function input parameters wherein members of said subset have a data-element identifier that matches said UI-field data-element identifier.

27. The apparatus of claim 26, wherein automatically selecting said one or more API function identifiers further comprises selecting one or more members of said subset wherein the selected one or more members have a structure identifier that corresponds to said ERP data table.

28. The apparatus of claim 26, wherein automatically selecting said one or more API function identifiers further comprises selecting one or more members of said subset wherein the selected one or more members have a structure identifier that corresponds to said table field of said ERP data table.

29. The apparatus of claim 21, the method further comprising determining a plurality of counts respectively indicating how many of said plurality of UI fields correspond to an input parameter of a respective one of said one or more identified API functions.

30. The apparatus of claim 29, wherein providing said API-function-identification UI comprises sorting said one or more API function identifiers in descending order according to said plurality of counts.
